(19) United States
(12) Patent Application Publication
(10) Pub. No.: US 2025/0087187 A1
(43) Pub. Date: Mar. 13, 2025

(54) INSTRUMENT STAND FOR MUSICAL INSTRUMENTS

(71) Applicant: Adam Hall GmbH, Neu-Anspach (DE)

(72) Inventors: Robin HENLICH, Usingen (DE); Markus RINK, Argenbühl (DE)

(21) Appl. No.: 18/883,021

(22) Filed: Sep. 12, 2024

(30) Foreign Application Priority Data
Sep. 12, 2023 (DE) 202023105265.7

(51) Int. Cl. G10G 5/00

(52) U.S. Cl. CPC G10G 5/00

(57) ABSTRACT

An instrument stand includes a ring-shaped base element, which is formed to be placed on a ground and an arm element, which extends away from the base element and is formed to support and/or hold a musical instrument above the base element. The base element includes an illumination unit, which is formed to emit light in a direction of a musical instrument accommodated by the instrument stand to illuminate a musical instrument.

### BACKGROUND

The invention relates to an instrument stand. This is used on the one hand to accommodate musical instruments, in particular a guitar, and on the other hand to illuminate the musical instrument, in particular the guitar.

Guitar stands are known from the prior art. These are usually only used to hold the guitar. The guitar is not described.

### SUMMARY

The instrument stand according to the invention allows the musical instrument to be illuminated when the musical instrument is accommodated by the instrument stand. Thus, the musical instrument is not only held or supported by the stand, but is also presented in a visually appealing manner. The instrument stand can therefore be used in a variety of ways, especially at home, in a studio, on a stage or in a store. The instrument stand is particularly advantageously formed to accommodate lute instruments, especially a guitar.

The instrument stand comprises a ring-shaped base element and an arm element. The base element is formed to be placed on a ground. In particular, at least one, for example ring-shaped, foot element made of plastic is provided to ensure a secure stand on the ground. The foot element can be made of a porous rubber material, for example. The circular arc contour of the base element is in particular oriented parallel to the ground, i.e. the ring-shaped base element lies on the ground. The arm element extends away from the base element. The arm element and base element are formed in one piece in particular. The arm element is formed to support and/or hold the musical instrument, in particular the guitar, above the base element. The term “above” refers to the side of the base element, which is opposite to the ground.

When the arm element of the instrument stand is formed to support the musical instrument, in particular the guitar, the musical instrument preferably sits on the base element. When, on the other hand, the arm element is formed to hold the musical instrument, in particular the guitar, it is preferable that the musical instrument, in particular the guitar, does not necessarily touch the base element. Regardless of the design of the arm element, at least part of the musical instrument, in particular the guitar, is always present above the base element.

The base element comprises an illumination unit. The illumination unit is formed to emit light in the direction of a musical instrument accommodated by the instrument stand to illuminate the musical instrument. The instrument stand is thus formed to illuminate the musical instrument independently. It is not necessary to use external illumination devices to present the musical instrument. Illumination from the base element means that illumination is always achieved regardless of the shape of the musical instrument, in particular the guitar.

The embodiments relate to preferred designs of the invention.

The illumination unit preferably comprises a spotlight. Such a spotlight is a spotlight with a small beam angle, which can illuminate a locally limited portion of the musical instrument relatively brightly. This allows at least individual partial portions of the musical instrument, in particular the guitar, to be optimally illuminated or highlighted.

It is particularly preferable for the spotlight to be pivotably arranged at the base element. This means that the illumination provided by the spotlight can be adjusted. In particular, the pivoting axis of the spotlight is oriented parallel to the circular arc shape of the base element. This allows the illumination by the spotlight to be fixed at different portions of the musical instrument, in particular the guitar. Preferably, the spotlight is arranged at a housing of the base element to be rotated around the pivot axis. In a particularly advantageous design, the spotlight is formed not to emit any light in a predefined orientation. This means that the spotlight can optionally be switched on and thus switched off by rotating it into the predefined orientation. The predefined orientation is preferably an orientation, in which the light from the spotlight does not hit the musical instrument or hits it only minimally.

Alternatively or additionally, the illumination unit advantageously comprises a surface illumination in the form of one ring segment or multiple ring segments. The shape of the one ring segment or the multiple ring segments follows in particular the shape of the base element, i.e. in particular the circular arc shape. Thus, on the one hand, a harmonious overall appearance of the instrument stand is achieved and, on the other hand, optimal illumination of the musical instrument, in particular the guitar, is provided from different directions. The illumination is provided in particular as mood illumination. It is particularly preferable for the spotlight to be coupled with the surface illumination to always comprise the same brightness and/or color of the respectively emitted light. The surface illumination is preferably LED strips. In particular, the LED strips are integrated into a housing of the base element.

An additional illumination element is preferably arranged at the arm element, which extends in particular along the arm element. Advantageously, the additional illumination element is an LED strip, which is particularly advantageously integrated into a housing of the arm element.

In a preferred embodiment, the surface illumination is coupled with the additional illumination element to always comprise the same brightness and/or color of the light emitted respectively in each case. The additional illumination element is particularly advantageous, when the arm element is formed to hold a guitar, in particular the head of a guitar. In this case, the guitar can be illuminated over a large part of its dimensions by the additional illumination element. In addition to the illumination by the illumination unit, optimal overall illumination is thus achieved, which in particular leads to an appealing presentation of the guitar.

A brightness and/or a color of the illumination unit and/or the additional illumination element is advantageously adjustable. This means that a desired illumination of the musical instrument, in particular the guitar, can always be selected. It is provided that the brightness and/or the color can be changed in particular by touching respectively a button, for example a capacitive button. This enables simple and effortless adjustment of the brightness and/or color. In particular, continuous adjustment is possible, for example by continuously changing the brightness and/or color as long as the button is touched. By providing buttons, in particular capacitive buttons, the design of the base element is simple and straightforward, with no moving switches or knobs, and thus in particular no interruptions in the design of the base element.

The base element comprises at least one receptacle, at which a corpus of the musical instrument, in particular a guitar, can be placed or supported. This is particularly advantageous, when the arm element is only used to support the musical instrument, in particular the guitar. In this case, the base element also serves as a receptacle for the corpus. It is particularly advantageous to have multiple, in particular two, receptacles to reliably hold the corpus.

In one design, the arm element preferably comprises a support element. A corpus of the musical instrument, in particular a guitar, can be placed against the support element to support the musical instrument, in particular the guitar. This is provided in particular, when a receptacle is also provided at the base element to accommodate the corpus of the musical instrument, in particular the guitar, in the receptacle of the base element on the one hand and to support it at the support element on the other hand. In this way, a reliable hold of the musical instrument, in particular the guitar, at the instrument stand is achieved.

In an alternative design, the arm element comprises a holder. A head of the musical instrument, in particular a guitar, can be attached to the holder. Advantageously, the holder is formed to be removable to fix it at an extension element. In this way, the arm element can be extended to change the distance between the base element and the holder. The holder is used in particular for the suspended receptacle of the musical instrument, especially the guitar, i.e. for example, the guitar hangs with its head at the instrument stand. A receptacle at the base element as described above is not absolutely necessary, but can nevertheless be provided for additional stabilization of the musical instrument, in particular the guitar.

Furthermore, it is preferred that the base element comprises a base surface. The base surface comprises a removable insert in a partial portion. In particular, the base surface is formed from or covered with a foam or other plastic to prevent damage to the musical instrument, in particular the guitar. The removable insert makes it possible to provide a recess, which is sometimes necessary due to the presence of strap connections of, for example, guitars. Thus, the instrument stand can be used for a plurality of different musical instruments, in particular different guitars.

### BRIEF DESCRIPTION OF THE DRAWINGS

Further details, advantages and features of the present invention are shown in the following description of embodiments with reference to the drawing. It shows in:

FIG. 1 a first schematic view of an instrument stand according to a first embodiment of the invention,

FIG. 2 a second schematic view of an instrument stand according to the first embodiment of the invention,

FIG. 3 a first schematic view of an instrument stand according to a second embodiment of the invention, and

FIG. 4 a second schematic view of an instrument stand according to the second embodiment of the invention.

### DETAILED DESCRIPTION

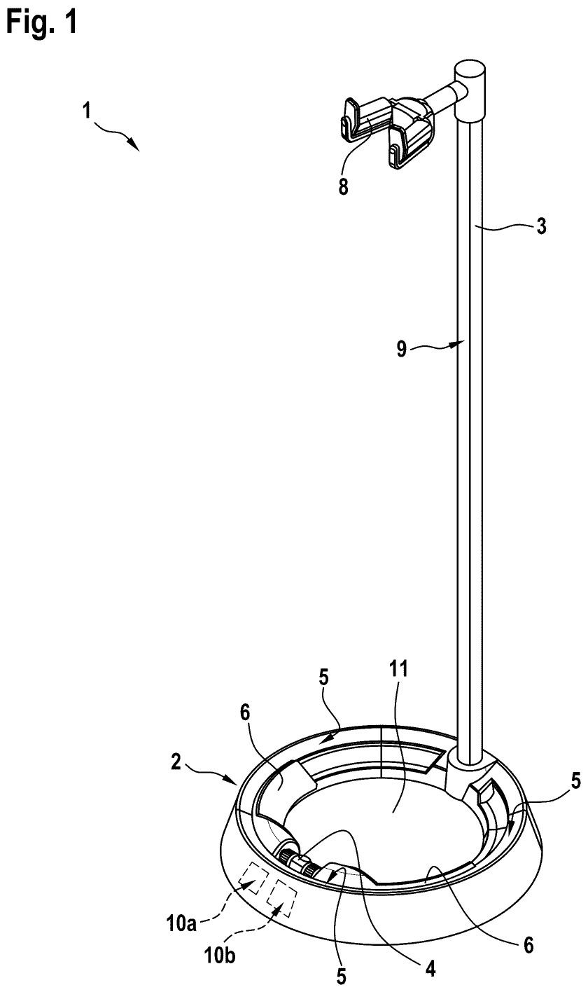

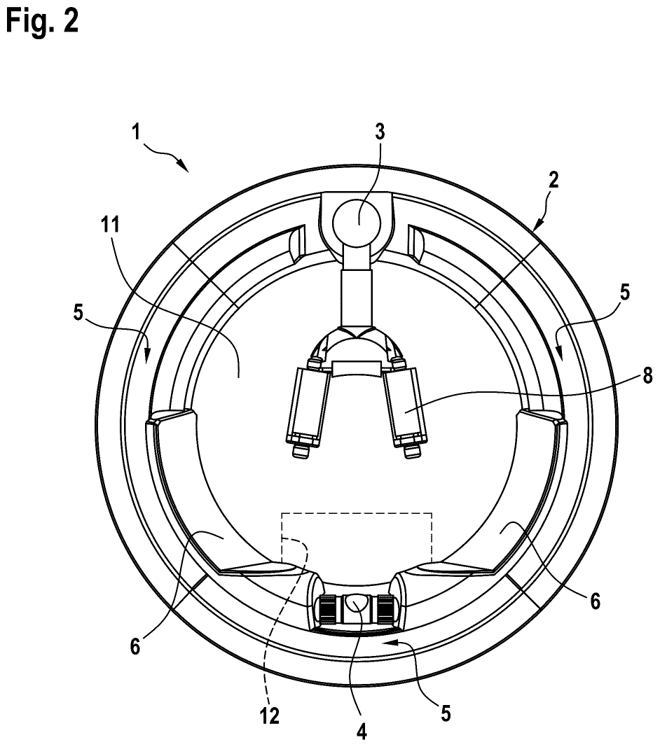

FIG. 1 schematically shows a first view of an instrument stand 1 according to a first embodiment of the invention. FIG. 2 shows a second schematic view of the instrument stand 1 according to the first embodiment of the invention. In the embodiment shown, the instrument stand 1 is a guitar stand to accommodate a guitar. The instrument stand 1 comprises a base element 2 and an arm element 3. The base element 2 is ring-shaped and formed to rest on a ground. The ring shape is oriented parallel to the ground. The arm element 3 extends away from the base element 2, wherein the arm element 3 is formed in one piece with the base element 2 in particular. In the embodiment shown, the arm element 3 extends vertically away from the ring shape of the base element 2.

The arm element 3 also comprises a holder 8. The holder 8 serves to accommodate a head of a guitar to hold the guitar. This ensures that the guitar hangs at the holder 8 and a corpus of the guitar is located above the base element 2. In this embodiment, the base element 2 comprises additional receptacles 6 to accommodate the guitar, wherein these receptacles 6 only serve to guide and not to hold a weight of the guitar. The guitar is thus held reliably and securely by the instrument stand 1. However, the receptacles 6 are not necessary; rather, the arm element 3 can also be designed, so that the guitar does not touch the base element 2 and comprises a distance from it.

The base element 2 comprises an illumination unit 4, 5, which is formed to emit light in a direction of a guitar accommodated by the instrument stand 1 to illuminate the guitar. In this embodiment, the illumination unit is formed by a pivotable spotlight 4 and a surface illumination 5. The spotlight 4 is pivotably arranged relative to a housing of the base element 2, wherein a pivoting axis is formed parallel to the ring shape of the base element 2. This allows the corpus of a guitar accommodated by the instrument stand 1 to be illuminated adjustably in different portions.

The surface illumination 5 is realized in particular by LED strips, which are integrated into the housing of the base element 2. In the embodiment shown, the surface illumination 5 is divided into three ring segments comprising the same curvature as the base element 2. In this way, a guitar accommodated by the instrument stand 1 is illuminated from different directions. In particular, the brightness and color of the emitted light can be adjusted.

Furthermore, an additional illumination element 9 is arranged at the arm element 3. The additional illumination element 9 extends along the arm element 3 and is also realized as an LED strip. In particular, the additional illumination element 9 is coupled to the surface illumination 5 of the base element 2 to emit light with the same color and the same brightness as the surface illumination 5. Preferably, the spotlight 4 is also coupled to the surface illumination 5 of the base element 2 and/or the additional illumination element 9 to emit light with the same color and the same brightness as the surface illumination 5.

The brightness and/or the color of the light emitted by the surface illumination 5 and/or the additional illumination element 9 can be changed in particular by touching respectively a button 10a, 10b. In particular, the buttons 10a, 10b are capacitive buttons. For example, one button 10a is used to adjust the brightness and another button 10b is used to adjust the color. By using buttons 10a, 10b, in particular capacitive buttons, no moving switches and/or buttons and/or other input elements are necessary. As a result, the design of the instrument stand 1 is simple and robust, wherein the adjusting of the color and/or brightness of the emitted light is simple and intuitive.

As shown in particular in FIG. 2, the base element 2 comprises a base surface 11. In particular, the base surface 11 is provided with a plastic material or formed of plastic material to prevent damage to a guitar accommodated by the guitar holder 1. In addition, the base surface 11 comprises a removable insert 12 in a partial portion. This insert 12 makes it possible to provide a recess in the base surface, for example, when the guitar comprises a strap connection. This means that the instrument stand 1 can be used universally for different guitars.

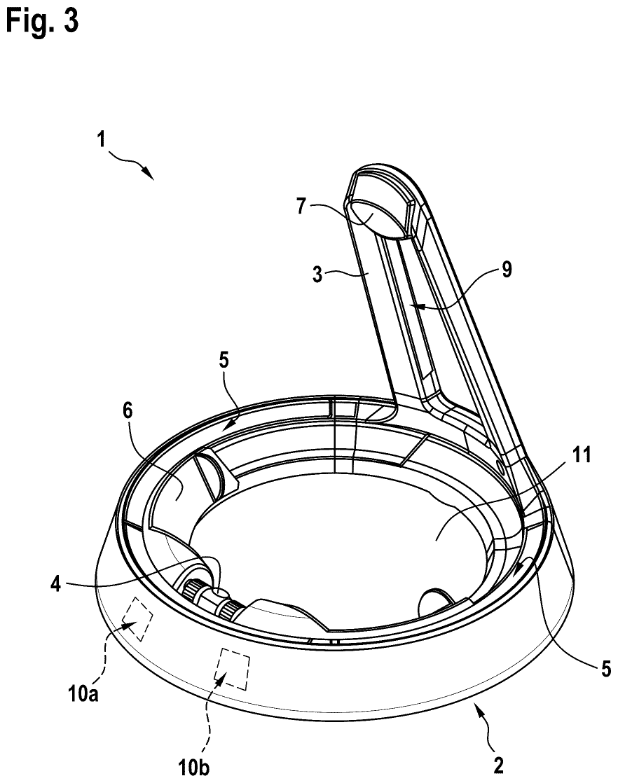

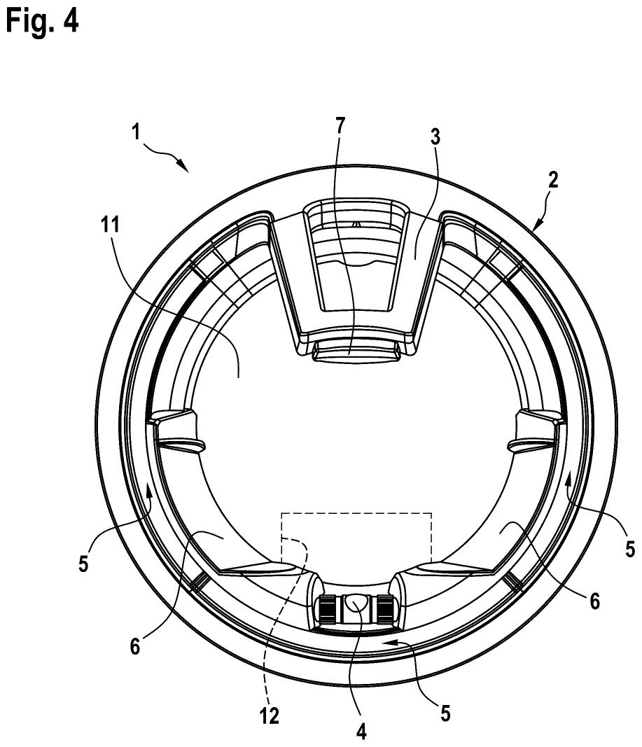

FIG. 3 schematically shows a first view of an instrument stand 1 according to a second embodiment of the invention. FIG. 4 shows a second schematic view of the instrument stand 1 according to the second embodiment of the invention. The instrument stand 1 comprises a base element 2 and an arm element 3. The base element 2 is ring-shaped and formed to rest on a ground. The ring shape is oriented parallel to the ground. The arm element 3 extends away from the base element 2, wherein the arm element 3 is formed in one piece with the base element 2 in particular. The second embodiment differs from the first embodiment mainly in the arm element 3, which in the second embodiment is shorter than in the first embodiment and in the second embodiment extends away from the ring shape of the base element 2 in the direction of a central axis of the base element 2.

The arm element 3 comprises a support element 7, at which a corpus of the guitar can be placed to support a guitar. The base element 2 comprises receptacles 6 to accommodate the corpus of the guitar. In particular, it is intended that these receptacles 6 serve to hold a large part of the weight of the guitar, while the support element 7 merely supports the corpus. The guitar is thus held reliably and securely by the instrument stand 1. In contrast to the first embodiment, in which the guitar hangs from the instrument stand 1, in the second embodiment the guitar stands at the instrument stand 1.

The base element 2 comprises an illumination unit 4, 5, which is formed identically to that described for the first embodiment. Buttons 10a, 10b are also present, which are formed identically as described for the first embodiment. Thus, the instrument stand 1 according to the second embodiment of the invention also enables optimal illumination of a guitar accommodated by the instrument stand 1.

In the second embodiment, the arm element 3 of the instrument stand 1 also comprises an additional illumination element 9. In this embodiment, the additional illumination element 9 is not provided to directly illuminate a guitar held by the instrument stand 1, but serves as accent illumination for the arm element 3 itself. Again, however, it is provided that the additional illumination element 9 is coupled with the illumination unit 4, 5, in particular with the surface illumination 5, to emit light with the same brightness and color.

The embodiment described is a guitar stand. Alternatively, the instrument stand 1 can also be formed for other instruments, in particular for other lute instruments.

In addition to the above written description of the invention, explicit reference is hereby made to the graphic representation of the invention in the figures for its supplementary disclosure.

List of reference signs

| | |
|---|---|
| 1 | instrument stand |
| 2 | base element |
| 3 | arm element |
| 4 | spotlight (illumination unit) |
| 5 | surface illumination (illumination unit) |
| 6 | receptacle |
| 7 | support element |
| 8 | holder |
| 9 | additional illumination element |
| 10a, 10b | (capacitive) button |
| 11 | base surface |
| 12 | removable insert |

1. An instrument stand comprising:
a ring-shaped base element, which is formed to be placed on a ground, and
an arm element, which extends away from the base element and is formed to support and/or hold a musical instrument, in particular a guitar, above the base element,
wherein the base element comprises an illumination unit, which is formed to emit light in a direction of a musical instrument accommodated by the instrument stand to illuminate a musical instrument.

2. The instrument stand according to claim 1, wherein the illumination unit comprises a spotlight.

3. The instrument stand according to claim 2, wherein the spotlight is arranged pivotably at the base element.

4. The instrument stand according to claim 1, wherein the illumination unit comprises a surface illumination in form of a ring segment or multiple ring segments, which in particular follow a shape of the base element.

5. The instrument stand according to claim 1, wherein an additional illumination element is arranged at the arm element and extends along the arm element.

6. The instrument stand according to claim 5, wherein a brightness and/or a color of the additional illumination element is adjustable, wherein the brightness and/or the color is changeable by touching respectively a button.

7. The instrument stand according to claim 1, wherein the base element comprises at least one receptacle, at which a corpus of a musical instrument, in particular a guitar, can be placed or supported.

8. The instrument stand according to claim 1, wherein the arm element comprises a support element, at which, to support a musical instrument, in particular of a guitar, a corpus of the musical instrument, in particular of the guitar, can be placed.

9. The instrument stand according to claim 1, wherein the arm element comprises a holder, at which a head of a musical instrument, in particular a guitar, can be accommodated.

10. The instrument stand according to claim 1, wherein the base element comprises a base surface, wherein the base surface comprises a removable insert in a partial portion.

11. The instrument stand according to claim 1, wherein a brightness and/or a color of the illumination unit is adjustable, wherein the brightness and/or the color is changeable in particular by touching respectively a button.
